(19) United States
(12) Patent Application Publication
(10) Pub. No.: US 2007/0112441 A1
(43) Pub. Date: May 17, 2007

(54) MODULAR LAYER FOR ABSTRACTING PERIPHERAL HARDWARE CHARACTERISTICS

(76) Inventors: Amir Shahindoust, Laguna Niguel, CA (US); Michael Yeung, Mission Viejo, CA (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/563,951

(22) Filed: Nov. 28, 2006

Related U.S. Application Data
(62) Division of application No. 10/108,531, filed on Mar. 28, 2002.

(51) Int. Cl. G05B 11/01

(52) U.S. Cl. 700/19

(57) ABSTRACT

An extensible device-independent and scalable modular software layer in a peripheral device. The modular software layer facilitates communication between components of the peripheral device. A hardware abstraction layer (HAL) of the peripheral device is configured in accordance with interface parameters of the modular software layer such that hardware characteristics of the peripheral device are abstracted therefrom and passed to the modular software layer.

This application is a divisional of U.S. patent application Ser. No. 10/108,531, filed Mar. 28, 2002.

### BACKGROUND OF THE INVENTION

1. Technical Field of the Invention

This invention is related to hardware control algorithms, and more particularly, to a modular approach that is device independent and uses hardware abstraction layer methodology to abstract device characteristics.

2. Background of the Related Art

Computer networks are more widely used than ever in business and industry to facilitate increased work productivity and system control. As innovations to network devices improve the communication with and functionality of the devices, the software interfaces and engines for those devices tend to follow implementation only for that particular model or family of devices. That is, the software is device dependent and does not follow an upwardly scalable path.

What is needed is a modular layer that uses hardware abstraction layer methodology to abstract the hardware characteristics of the network device or peripheral. For example, where the network device is a network printer, the innovative modular layer would abstract the printer hardware characteristics from the applications that are used to print to, administer, and control the printer.

### SUMMARY OF THE INVENTION

The present invention disclosed and claimed herein, in one aspect thereof, comprises an extensible device-independent and scalable modular software layer in a peripheral device. The modular software layer facilitates communication between components of the peripheral device. A hardware abstraction layer (HAL) of the peripheral device is configured in accordance with interface parameters of the modular software layer such that hardware characteristics of the peripheral device are abstracted therefrom and passed to the modular software layer.

### BRIEF DESCRIPTION OF THE DRAWINGS

For a more complete understanding of the present invention and the advantages thereof, reference is now made to the following description taken in conjunction with the accompanying drawings, in which:

FIG. 1 illustrates the internal structure and components of the driver development kit (DDK), according to a disclosed embodiment;

FIG. 2 illustrates a general block diagram of a device control module;

FIG. 3 illustrates a block diagram of signal and data flow between the various components of the DDK for a printing process;

FIG. 4 illustrates a flow chart of the general process for of directing output to a printer, according to a disclosed embodiment;

FIG. 5 illustrates a general block diagram of the interaction with the DQM;

FIG. 6 illustrates a block diagram of interfaces of the RIPM;

FIG. 7 illustrates a block diagram of interfaces of the Print Data Manager;

FIG. 8 illustrates a flow chart of activities processed by the Print Data Manager;

FIG. 9 illustrates a general block diagram of the interaction of the network manager, its spooler, and subsequent JobM and RIPM data flow;

FIG. 10 illustrates a block diagram the multithreaded features of the PDM;

FIG. 11 illustrates a block diagram representing a functional overview of the ETM; and

FIG. 12 illustrates a system block diagram of a peripheral configured to utilize the disclosed architecture.

### DETAILED DESCRIPTION OF THE INVENTION

The disclosed internal structure is designed to accommodate communication between all the components in a component-based development of an imaging platform architecture and, abstract any hardware and platform dependencies (e.g., operating system of the controller associated with the peripheral device). A series of modules and functions are provided that communicate with low-level controller code (e.g., C language code), abstract any hardware characteristics, and create a connection point channel of communication to higher software layers such as a Software Development Kit (SDK) and/or the applications. The implementation uses polymorphic relationships between the sub-components to abstract the lower level code and hardware dependencies. The structure is sufficiently versatile to be portable, useable, and scalable for a variety of peripheral devices (e.g., copiers) and many operating systems.

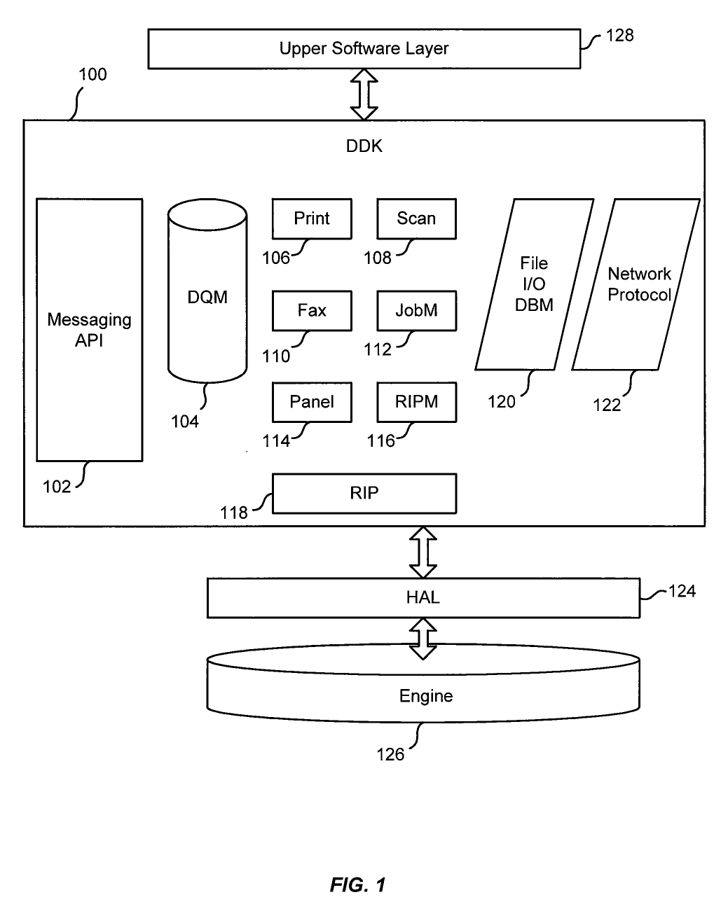

Referring now to FIG. 1, there is illustrated a general block diagram of a driver development kit (DDK) modular software layer 100. Note that the term abstract refers to separating the implementation of hardware-specific code from the rest of the modules of the DDK software layer. For example, all printers do print and have a function that can be called print. However, the print function on a specific model can be different than he print function on a different model. The abstraction of this difference is the provided by the disclosed architecture, in that the DDK modular software layer 100 only calls the print function, and does not care about the how the print function actually works. The architecture is object-based to facilitate easy plug-in and removal of objects according to the particular device application. The only code that is device-specific is that associated with a hardware abstraction layer (HAL) 124. All modules above the HAL 124 are present in each device application and can be plugged in or out based upon that particular device. Note that the disclosed architecture is not limited to the modules illustrated in FIG. 1, but may include other modules suitably configured for the particular device application. The DDK software layer 100 covers the modules necessary to print and administer the peripheral device (e.g., a copier) locally and through a network, e.g., sending status information about the peripheral device to clients, setting the peripheral on-line/off-line according to a client request, configuring the network settings, and modifying device attributes according to client requests. A messaging application programming interface (messaging API) 102 facilitates “mail-enabled” communication between the various sub-components, and is a standard way of providing communication services to applications so that they can send and receive blocks of data, documents, files, etc., directly from within applications. The messaging API 102 is independent of platform operating system and transport protocol. A document queue manager (DQM) 104 provides queue functionality for the system. Other components include a print component 106 for handling print jobs, a scan component 108 for handling scanning operations, a fax component 110 for handling facsimile operations, a job manager (JobM) component 112 for handling job control functions, a panel component 114 for handling front panel control input from an operator, a raster image processor manager (RIPM) component 116 for handling image processing by interpreting the document and working with a RIP processor (RIP) 118 for converting (i.e., “RIPing”) the document into an image format that is compatible with an input/output engine 126. Other components also include a file input/output (I/O) database management (DBM) component 120 for managing file I/O, and a network protocol component 122 for providing protocol interfacing for network communications. The network protocol component is suitably adapted to accommodate such protocols as TCP/IP, IPX/SPX, FTP, SMTP, IMAP, and others. All of these components are designed to function with the HAL 124, which HAL 124 interfaces to the engine 126 for interfacing with a number of output devices. As mentioned hereinabove, the DDK modular software layer 100 facilitates communication of the device characteristics to the an upper software layer 128, which upper softer layer 128 includes the SDK or other user applications, e.g., word processors, etc.

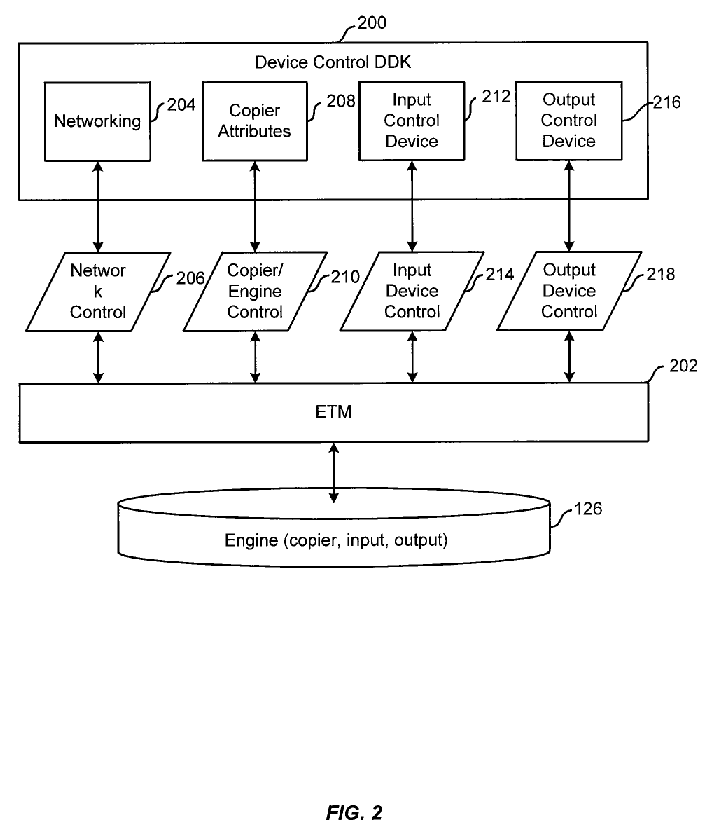

Referring now to FIG. 2, there is illustrated a general block diagram of a device control module 200 (similar to DDK 100). Discussion for this particular illustration is in the context of a copier. However, the discussion also applies to many different network peripheral devices such as a facsimile machines, printers, scanners, etc. The device control module 200 is responsible for sending status information about the copier and the controller to clients, setting the copier online/off-line per a client request, configuration of the network settings per a client request, and modifying copier attributes requested by a client. The device control module 200 sends the status information, attributes, and I/O device information via corresponding internal components suitably implemented to perform such functions, to an engine transport manager (ETM) 202. The information from the device control module 200 is communicated to the ETM 202 via corresponding modules. The ETM 202 performs the hardware abstract layer functions of the HAL 124 of FIG. 1.

Accordingly, a network control component 204 of the device control module 200 interfaces to a network control module 206 that facilitates communication of network control information to the ETM 202. The network control module 206 consists of all the components necessary to setup different network settings, including enabling or disabling different network protocols, setting different parameters of each protocol, etc.

A copier attributes component 208 of the device control module 200 interfaces to a copier/engine control module 210, which control module 210 facilitates communication of copier and engine control information to the ETM 202, such as modifying and reporting the modifiable attributes of the copier.

An input control device component 212 of the device control module 200 interfaces to an input device control module 214 that facilitates input device control information of the copier to the ETM 202, such as paper tray selection, cassette, LCF (large capacity feed), etc., including paper size (read only), media type, load status (paper empty, half full, full) (read only), and location.

An output control device component 216 of the device control module 200 interfaces to an output device control module 218 that facilitates output device control information of the copier to the ETM 202, e.g., devices such as finishers, staplers, and hole punchers.

The ETM 202 then communicates information of the modules (206, 210, 214, and 218) to the device engine 126, which device engine 126 handles copier functions such as I/O control, etc.

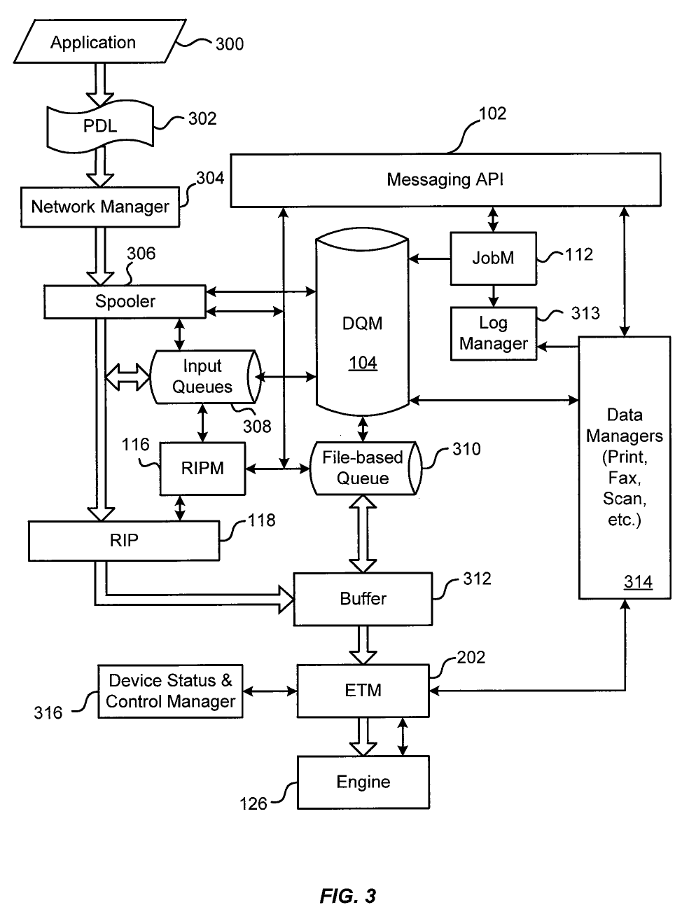

Referring now to FIG. 3, there is illustrated a block diagram of signal and data flow between the various components of the DDK 100 for a printing process. In a network-based implementation, an application 300 is given a command by a user to start printing using a specified printer driver. The printer driver generates a PDL (Page Description Language) document in a PDL block 302, and sends it through an object-based Network Manager module 304 to a spooler 306. The spooler 306 sends a message to the JobM 112 via the messaging API 102 to create a job. The JobM 112 uses the DQM 104 to create the job. The DQM 104 creates a job record and assigns a job ID. The spooled job is stored in an input queue 308 and its corresponding job record is then stored in a file-based queue 310. The JobM 112 sends the job ID back to the spooler 306 via the messaging API 102. The spooler 306 then starts spooling the job.

After spooling the first page of the job, the spooler 306 sends a message to the JobM 112 so the job can be RIPed. The JobM 112 sends a message to the RIPM 116 via the messaging API 102 to start RIPing the job. The RIPM 116 receives the start message, allocates buffer space in a buffer 312 for the face data, and signals the RIP 118 to start RIPing the job to output image data. The face data includes a face record as the header and then compressed image data. The RIP 118 stores the image data to the buffer 312, also sending PJL (Print Job Language) data back to a RIPM 116 for parsing. After the RIP 118 processes the first page of the job, the RIPM 116 sends a message to the JobM 112. The JobM 112 then sends a message (“job ready for print”) to an object-based print data manager (PDM) 314 when the job is the next in the queue 310 to be printed. The PDM 314 then reads and updates the job record from the queue 310. Data from PDM 314, as well as data from JobM 112 is communicated to Log Manager 313 for logging thereof. The PDM 314 then creates a control block (CB) of memory in the peripheral device through which to send the data to the ETM 202. The PDM 314 sends a command to the ETM 202 to send the data. The ETM 202 then reads the data from the control buffer, and then commands the engine 126 to start transfer of the data as it receives it from the ETM 202. The ETM then sends the data to the engine 126 and reports the status. A device status and control manager component 316 receives the status of the engine 126 through the ETM 202, which in turn transmits this status information to any module requesting such information.

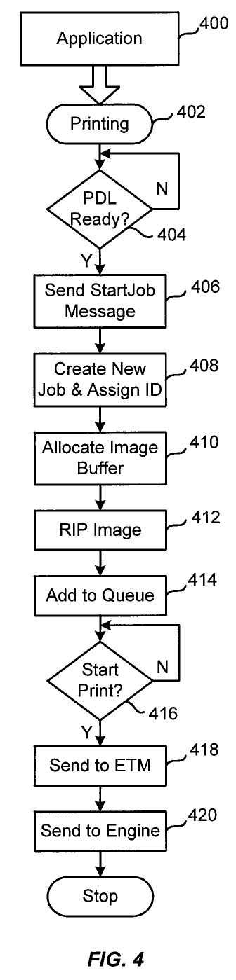

Referring now to FIG. 4, there is illustrated a flow chart of the general process for of directing output to a printer, according to a disclosed embodiment. Flow begins at an application block 400 where a user of an application directs the application to output a document to a particular printer for output. Flow is then directed to a printing block 402 to start the printing process. In a decision block 404, a determination is made as to whether the printer driver has converted the application document to a PDL-formatted file. If not, flow is out the “N” path back to the input of the decision block 404 to continue monitoring for PDL output. If so, flow is out the “Y” path to a function block 406 where a StartJob message is sent to initiate spooling of the print process. In a function block 408, a new job is created for tracking the printing process through the system, and an associated Job ID is assigned. Buffer space is then allocated in a buffer for the job, as indicated in a function block 410. The RIP processor 118 then RIPs the job into an image format, as indicated in a function block 412. In a function block 414, the RIPed job is then placed into the file-based queue 310 to await output to the designated printer. In a decision block 416, a decision is made as to whether it is time to start printing the job. If not, flow is out the “N” path back to the input of the decision block 416 to continue monitoring for the signal to commence printing. If so, flow is out the “Y” path of decision block 416 to a function block 418 to send the job to the ETM 202. The ETM 202 then forwards the job to the engine 126 for output processing as shown in block 420. Flow then reaches a Stop block.

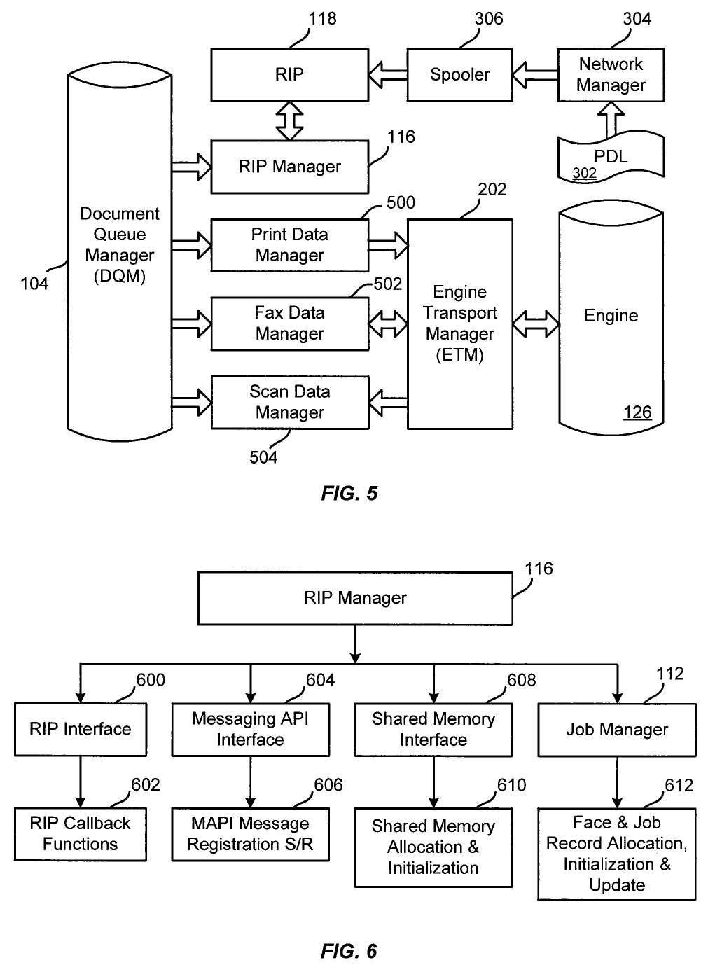

Referring now to FIG. 5, there is illustrated a general block diagram of module interaction with the DQM 104. The DQM 104 is an object-based module that can either be run as a standalone process or be dynamically shared with other modules to provide job queue functionality. The DQM 104 is part of the job management mechanism, and it can be part of print, fax, scan, and/or other components that require job management. The responsibility of the DQM 104 in this architecture is to provide queue functionality for the rest of the system. The DQM 104 is responsible for creating a job and assigning a job ID, creating different queues, adding, moving, and removing jobs in queues based upon requests from other modules. The DQM 104 dies this by creating different queues that hold the job in different stages, from inception to the final state. This involves creating, moving, and providing job and page information to other modules, and keeping track of jobs.

The PDL algorithm 302 formats the application output to a PDL format and sends output to the Network Manager 304, which forwards it to the spooler 306. The spooler 306 then sends the job to the RIP 118 for image processing under control of the RIPM 116. The DQM 104 communicates with RIPM 116 to facilitate queue logistics for the object-based data manager 314, which comprise a PDM 500 (similar to PDM 314), a fax data manager 502, and a scan data manager 504, and other data managers suitably implemented. The job of each one is to process the face files and route them to the corresponding section of the engine or the controller. Thus a document that has been RIPed will be enqueued under control of the DQM 104, and for output control under the corresponding data manager. For example, where an application user has directed output to a network facsimile machine, the DQM 104 coordinates RIPing of the application output with the RIPM 116 in accordance with the driver associated with the fax machine. The DQM 104 enqueues the RIPed document in the appropriate queue and notifies the fax data manager 502, such that the fax data manager 502 can then direct output to the ETM 202 for output ultimately to the fax machine. Note that data flow between the ETM 202 and the fax data manager 502 is illustrated as bi-directional, indicating that information received from the fax machine may be brought into the system and redirected for output to another fax or other peripheral suitably configured.

The major tasks of the PDM 500 are: PDM initialization, PDM termination, monitoring device/cassette/on/off, print jobs, handle engine events, handle messaging, and handle errors.

The fax data manager 502 is an object module that runs as a standalone process to receive incoming faxes from client computers through the DQM 104. The fax data manager 502 converts the data to MMR/MR/MH format from the format that the RIPM 116 supports, resizes to the desired paper size, and scales to the desired resolution, before it sends the data to the engine 126 through the ETM 202.

The scan data manager (SDM) 504 is responsible for transferring a scan job from the engine 126 to a repository in the controller. The SDM 504 must provide modules to create user folders in the database and store the scanned document. It also must include provisions for routing of the scan jobs to different destinations using any of the transfer protocols, for example SMTP, or others. The scan data manager 504 is suitably configured within the disclosed architecture to receive information from the ETM 202, as indicated by the data flow arrow in FIG. 5. Thus information that has been scanned with a scanner can be imported into the system through the engine 126 and redirected to other output peripherals, or simply stored on the user machine, or a network device.

Referring now to FIG. 6, there is illustrated a block diagram of interfaces of the object-based RIPM 116. The RIPM 116 includes a RIP interface 600 for interfacing to the RIP 118. The RIP interface 600 accesses RIP Callback functions 602 for facilitating communication to the RIP 118. The RIPM 116 also communicates with a messaging API interface 604 (similar to the messaging API 102) to facilitate send/receive registration 606 of messages to the messaging API 102. The RIPM 116 also communicates with a shared memory interface 608 to a memory manager (hereinafter denoted as a shared memory manager (SMM), and described hereinbelow) to facilitate shared memory allocation and initialization 610. The RIPM 116 also communicates with the JobM 112, which facilitates a corresponding function 612 of face and job record allocation, initialization, and update.

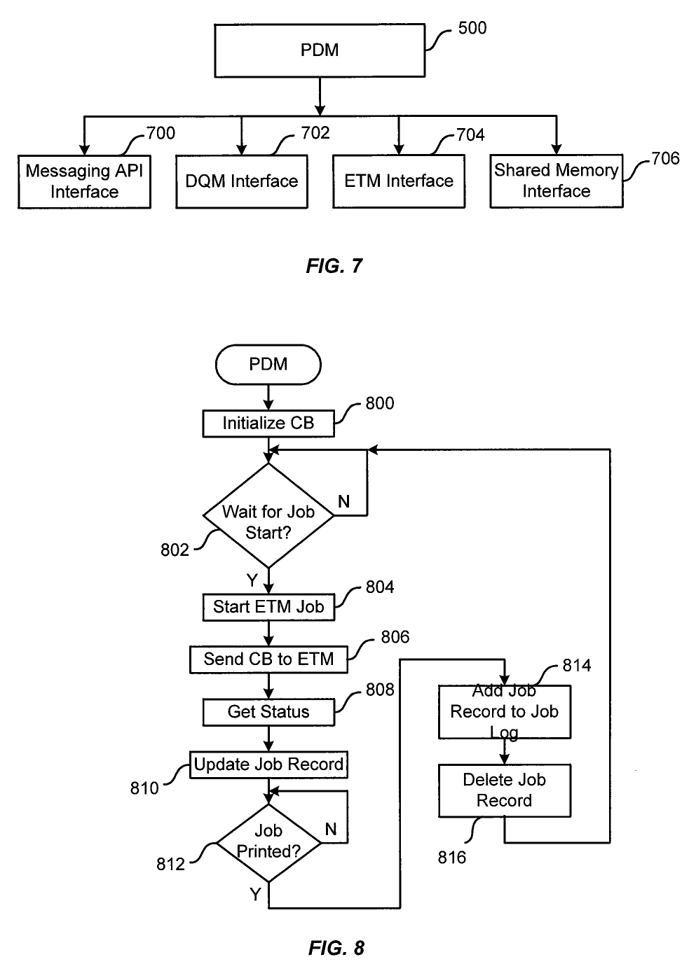

Referring now to FIG. 7, there is illustrated a block diagram of interfaces of the Print Data Manager 500. The PDM 500 communicates to the messaging API 102 via a messaging API interface 700, the DQM 104 via a DQM interface 702, the ETM 202 via a DQM interface 704, and the SMM via a shared memory interface 706.

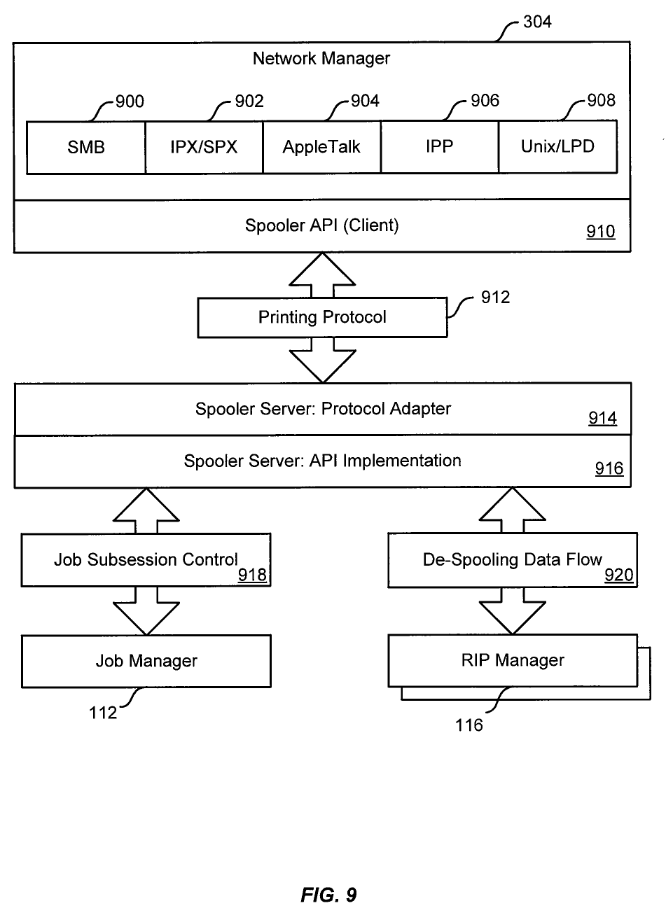

Referring now to FIG. 8, there is illustrated a flow chart of activities processed by the Print Data Manager 500. Flow begins at a function block 800 where the CB memory location is initialized. Flow is to a decision block 802 where the PDM 500 determines if a StartJob message has been received. If not, flow is out the “N” path back to the input of the decision block 802 to continue monitoring for the message. If so, flow is out the “Y” path to a function block 804 to start the job to the ETM 202. In a function block 806, the CB memory location data is sent to the ETM 202. The status of the job in the ETM 202 is then returned using the device status and control manager 316, as indicated in a function block 808. In a function block 810, the job record is updated. Flow is then to a decision block 812 where it is determined if the job has completed printing. If not, flow is out the “N” path back to the input of the decision block 812 to continue monitoring the process. If the job has completed printing, flow is out the “Y” path to a function block 814 to add the job record to a job log file. In a function block 816, the job record is then deleted from system memory, retaining a copy of the job only in the job log. Flow then loops back to the input of decision block 802 to monitor for the receipt of the next StartJob message.

Referring now to FIG. 9, there is illustrated a general block diagram of the interaction of the network manager 304, its spooler 306, and subsequent JobM 112 and RIPM 116 data flow. The network manager 304 is a component that is responsible for the loading and unloading of network protocols and, initiation and termination of network printing services based on network configurations. When a configuration changes, the network manager 304 responds by either restarting the effective components or requests a system restart. The network manager 304 is suitably adapted to accommodate many network protocols, including an SMB (Server Message Block, a Microsoft presentation layer protocol providing file and print sharing functions) interface 900, an IPX/SPX interface 902, an AppleTalk® interface 904, and IPP (Internet Printing Protocol) interface 906, and a Unix/LPD (Line Printer Daemon) interface 908. Each of the interfaces communicates to a spooler API 910 that transmits PDL information (where printing is utilized) via a printing protocol 912 to the spooler 306. The spooler can be a printer server having a network interface adapter 914 suitably adapted to accommodate the communication protocol. The PDL information is communicated through the adapter 914 through a spooler API 916 of the spooler to either the JobM 112 via a job session control interface 918 or to the RIPM 116 via a de-spooler interface 920.

The spooler 306 is one of the front-layer object-based components of the DDK 100 internal structure, right behind the network manager 304. As the name suggests, the main task of the spooler 306 is to receive print jobs from clients, store the print data in a persistent storage mechanism and place the jobs in a queue. The spooler 306 is responsible for servicing job control requests received from the clients through the network manager 304. These requests are serviced by forwarding them to the JobM 112. The reply from the JobM 112 is then forwarded back to the client. This facilitates use of a central repository for all jobs inside the controller, right from the creation of the job. The spooler 306 publishes the thin clients, i.e., associates the particular thin client with the job and provides this ownership information when requested for networking layers accessing spooling and job control operations. The spooler client 910 forwards these requests to the spooler process via the printing protocol 912. A standards-based protocol is utilized for communicating between the spooler client 910 and the spooler server 306. This allows networking client applications already written for this protocol to use the spooler 306 directly without the help of the client library. For example, if the LPD protocol is used, it enables the spooler 306 to be directly used by standard networking modules like Samba (for SMB printing), LPR (for Unix printing), CUPS (for IPP printing), or any other module written to use Unix/LPD print servers.

The JobM 112 is an object-based module that runs as a standalone process to control jobs, manager queues, and schedule jobs from start to finish, and interfaces with components such as the spooler 306, the RIPM 116, object-based data managers 314 (i.e., print, scan, fax, etc.), the status manager 316, the log manager 313, and DQM 104 to monitor the job flow through messaging API 102. Following is the list of tasks for which the JobM 112 is responsible: create a job, pause a job, resume a job, delete a job, start a job, reprint a job, pause a queue (printer), release a queue, move jobs between queues, and schedule jobs for different operations. The JobM 112 runs as a daemon and monitors activities of systems incorporating multi-functions, such as printing, faxing, and scanning.

The RIPM 116 is responsible for RIPing and interpreting the input PDL document and, generating a job record file and a face file for each physical page to be printed. The face file includes a face record as the header and then compressed image data. The following is the list of tasks performed by the RIPM 116: wait for a job read to RIP message from the JobM 112, initialize the RIP library, initialize a face record (one record per page), allocate memory to be used by the RIP 118 to store raw image data, parse the PJL (Print Job Language) commands coming from the RIP 118 and update the face record accordingly, and send a message to the JobM 112 notifying it that the job has been RIPed.

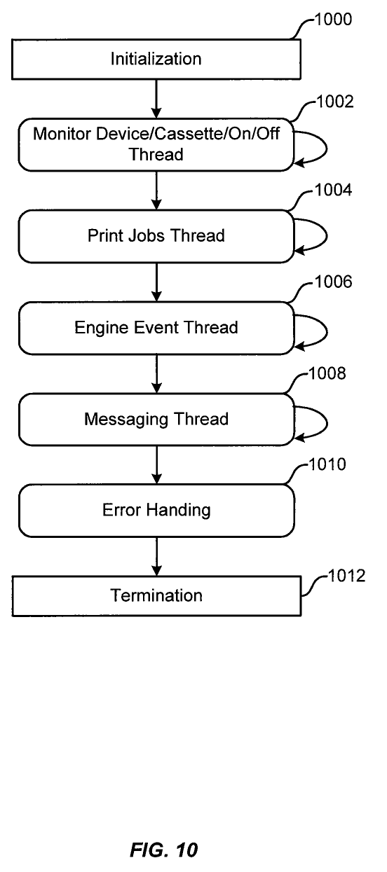

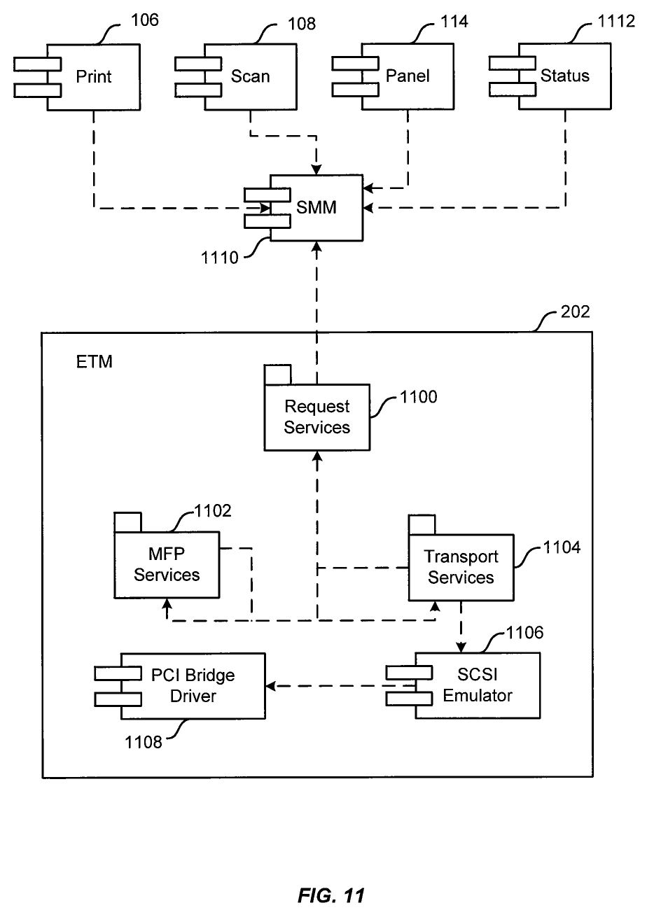

Referring now to FIG. 10, there is a block diagram illustrating the multithreaded features of the PDM 500. The PDM 500 is adapted to perform a number of operations: initialization procedures 1000; in a monitor block 1002, monitor the printing device, cassette status, on/off signals, etc.; a print job thread 1004 for managing data related to one or more print jobs; an engine event thread 1006 for processing the status of the engine 126; a messaging thread 1008 for managing messaging to and from the printer related to the printing process; an error-handling thread 1010 for managing error handling related to the printer; and a termination procedure 1012 executed for termination of the print process.

Referring now to FIG. 11, there is illustrated a block diagram representing a functional overview of the ETM 202. The ETM 202 provides the implementation of a protocol that acts as a bridge between the print component 106, scan component 108, panel component 114 (for front panel display and keyboard interface by a user), and status component 1112 and, the engine 126. Using shared memory segments under control of a shared memory manager (SMM) 1110 provides communication between components and the ETM 202. The ETM 202 communicates with the engine 126 by emulating the SCSI protocol. The ETM 202 manages the services it provides by distributing its operation over four layers: the ETM request services 1100; the MFP (Multi-Function Peripheral) services 1102; transport services 1104; and SCSI emulation services 1106. The ETM 202 also includes a PCI bridge driver 1108 for passing SCSI commands across the PCI interface bus of the ETM 202 to any PCI devices.

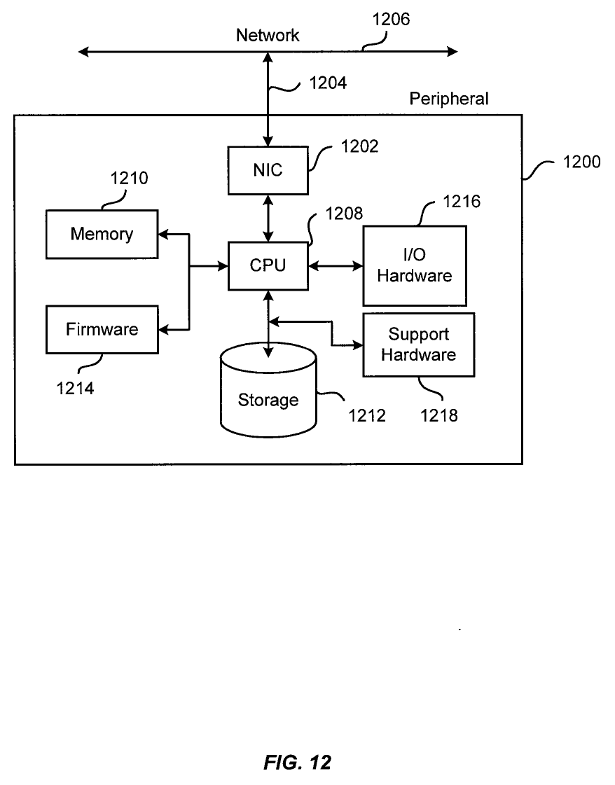

Referring now to FIG. 12, there is illustrated a system block diagram of a peripheral 1200 configured to utilize the disclosed architecture. The peripheral 1200, in this particular embodiment, is a network peripheral such as a network printer, or copier. Other such peripheral devices include, but are limited to, a facsimile machine, and scanner, both suitably designed to accommodate and operate utilizing the disclosed modular software architecture. Note also that the peripheral device need not be a network device, but a device that connects directly to a personal user computer, and does not offer network access thereto. As illustrated, the peripheral 1200 includes a network interface device (NIC) 1202 for facilitating connectivity via a communication link 1204 to a network 1206. The network 1206 may be a LAN, WAN, or even a global communication network such as the Internet. The communication link 1204 may be a hardwired connection that uses, for example, cable, or may even be a wireless implementation operating in accordance with common air protocols such as Bluetooth.

The peripheral 1200 includes a main processor 1208 for controlling all onboard processes. The processor 1208 has associated therewith a memory 1210 utilized during operation of the peripheral 1206. The memory 1210 is sufficiently large to accommodate the memory processes mentioned hereinabove in FIG. 11 with respect to the SMM 1110. The peripheral 1200 also includes a mass storage device 1212, e.g., a hard drive, accessible by the processor 1208 for storing and retrieving software applications and data, user logs, peripheral activity logs, etc., or any other software and/or data the operator desires to store thereon. For example, an operating system such as an embedded Windows® or Unix operating system can be stored thereon that is launched upon startup of the peripheral 1200. The mass storage device 1212 can also be a large amount of RAM memory similar to the memory 1210. The peripheral 1200 also includes a non-volatile memory (e.g., EEPROM) or firmware 1214 that stores the start-up routines for bringing the peripheral 1200 on-line for operation.

The main processor 1208 communicates with an I/O apparatus 1216, which apparatus 1216 accommodates the physical input/output of the peripheral device 1200. For example, if the peripheral 1200 is a printer, the apparatus 1216 includes all of the hardware used to process the text to the paper and provide the finished output of a printed document. If the peripheral 1200 is a scanner, the I/O hardware 1216 includes the scanning hardware. Optionally, the peripheral 1200 may also include support controller hardware 1218 in communication with the main processor 1208, and having access to all other onboard devices, and software. The support controller hardware 1218 would then include one or more secondary processors utilized to off-load some of the program execution requirements from the main processor 1208, for example, the managerial functions of the JobM 112, RIPM 116, RIP processor, etc. The disclosed modular object-based software architecture is configured for this particular peripheral 1200 and then loads upon startup. As mentioned hereinabove, the architecture is scalable and platform independent, thus allowing utilization with any number of different peripherals 1200.

Although the preferred embodiment has been described in detail, it should be understood that various changes, substitutions, and alterations can be made therein without departing from the spirit and scope of the invention as defined by the appended claims.

What is claimed is:

1. A system for scalable inter-component communication in a document processor comprising:
means adapted for receiving hardware data representative of hardware associated with performing at least one selected document processing operation;
means adapted for isolating a plurality of available subcomponents associated with completing the at least one selected document processing operation in accordance with the hardware data;
means adapted for generating dependency data representative of a testing of the plurality of subcomponents for hardware dependencies therebetween;
abstraction means adapted for generating a set of ordered controller instructions for operating the hardware in accordance with the hardware data and the dependency data;
means adapted for installing the controller instructions for use by a controller associated with a document processing device; and
means adapted for completing a document processing operation on the document processing device in accordance with generated controller instructions.

2. The system for scalable inter-component communication in a document processor of claim 1 wherein the document processing operation includes printing, faxing, scanning, document storage, and document transmission.

3. The system for scalable inter-component communication in a document processor of claim 1 wherein the subcomponents include a job manager component, a network manager component, a data manager component, a queue manager component, a spooling component, a image processing manager component, and a messaging interface component.

4. The system for scalable inter-component communication in a document processor of claim 3 wherein the job manager component functionality includes controlling a job, managing at least one queue, and scheduling a job.

5. The system for scalable inter-component communication in a document processor of claim 3 wherein the data manager component functionality includes print job management, facsimile job management, and scan job management.

6. The system for scalable inter-component communication in a document processor of claim 5 wherein print job management includes initialization of a print job, processing of a print job, and generating print job status.

7. The system for scalable inter-component communication in a document processor of claim 5 wherein facsimile job management includes receiving incoming facsimile data, formatting received facsimile data, processing of a facsimile job, and generating facsimile job status.

8. The system for scalable inter-component communication in a document processor of claim 5 wherein the scan job component includes receiving scan job data, processing of a scan job, generating scan job status, storing scan job data, and routing of scan job data.

9. The system for scalable inter-component communication in a document processor of claim 3 wherein the queue manager component functionality includes creating job queues, distributing job queues to available subcomponents, monitoring job queues, and generating queue status.

10. The system for scalable inter-component communication in a document processor of claim 3 wherein the spooler component functionality includes receiving job data, storing job data, and processing job data.

11. The system for scalable inter-component communication in a document processor of claim 3 wherein the imaging processor manager component functionality includes generating a job file, generating a face file, allocating storage for storing image data, and generating job status.

12. The system for scalable inter-component communication in a document processor of claim 1 wherein the document processing device includes a printing device, a facsimile device, a scanning device, and a multifunctional peripheral device.

13. A method for scalable inter-component communication in a document processor comprising the steps of:
receiving hardware data representative of hardware associated with performing at least one selected document processing operation;
isolating a plurality of available subcomponents associated with completing the at least one selected document processing operation in accordance with the hardware data;
generating dependency data representative of a testing of the plurality of subcomponents for hardware dependencies therebetween;
generating a set of ordered controller instructions for operating the hardware in accordance with the hardware data and the dependency data;
installing the controller instructions for use by a controller associated with a document processing device; and
completing a document processing operation on the document processing device in accordance with generated controller instructions.

14. The method for scalable inter-component communication in a document processor of claim 13 wherein the document processing operation includes printing, faxing, scanning, document storage, and document transmission.

15. The method for scalable inter-component communication in a document processor of claim 13 wherein the subcomponents include a job manager component, a network manager component, a data manager component, a queue manager component, a spooling component, a image processing manager component, and a messaging interface component.

16. The method for scalable inter-component communication in a document processor of claim 15 wherein the job manager component functionality includes controlling a job, managing at least one queue, and scheduling a job.

17. The method for scalable inter-component communication in a document processor of claim 15 wherein the data manager component functionality includes print job management, facsimile job management, and scan job management.

18. The method for scalable inter-component communication in a document processor of claim 17 wherein print job management includes initialization of a print job, processing of a print job, and generating print job status.

19. The method for scalable inter-component communication in a document processor of claim 17 wherein facsimile job management includes receiving incoming facsimile data, formatting received facsimile data, processing of a facsimile job, and generating facsimile job status.

20. The method for scalable inter-component communication in a document processor of claim 17 wherein the scan job component includes receiving scan job data, processing of a scan job, generating scan job status, storing scan job data, and routing of scan job data.

21. The method for scalable inter-component communication in a document processor of claim 15 wherein the queue manager component functionality includes creating job queues, distributing job queues to available subcomponents, monitoring job queues, and generating queue status.

22. The method for scalable inter-component communication in a document processor of claim 15 wherein the spooler component functionality includes receiving job data, storing job data, and processing job data.

23. The method for scalable inter-component communication in a document processor of claim 15 wherein the imaging processor manager component functionality includes generating a job file, generating a face file, allocating storage for storing image data, and generating job status.

24. The method for scalable inter-component communication in a document processor of claim 13 wherein the document processing device includes a printing device, a facsimile device, a scanning device, and a multifunctional peripheral device.
